(19) United States
(12) Patent Application Publication
(10) Pub. No.: US 2002/0092576 A1
(43) Pub. Date: Jul. 18, 2002

(54) Pre-assembled hose and ring assembly

(76) Inventor: David B. Miller, Caesarea (IL)

Correspondence Address: Michael L. Mau, Mau & Krull, P.A., Suite E, 1250 Moore Lake Drive East, Fridley, MN, 55432, US

(21) Appl. No.: 09/995,009

(22) Filed: Nov. 26, 2001

Related U.S. Application Data
(63) Continuation of application No. 09/833,783, filed on Apr. 12, 2001.
(60) Provisional application No. 60/197,263, filed on Apr. 14, 2000.

(51) Int. Cl. F16L 3/00

(52) U.S. Cl. 138/106; 138/107; 138/108

(57) ABSTRACT

An irrigation hose (50) is preassembled at a factory with a plurality of clips (10, 30), thereby providing for reduced labor and installation time at the irrigation site.

This application is a continuation of U.S. application Ser. No. 09/833,783 filed Apr. 12, 2001, entitled Pre-Assembled Hose and Ring Assembly and claims benefit of application Ser. No. 60/197,263 filed Apr. 14, 2000.

### BACKGROUND OF THE INVENTION

1. Field of the Invention

This invention relates generally to a clip ring for attachment to a dripper line hose and more particularly to a dripper line hose that has the clips preassembled at the factory.

2. Description of the Prior Art

Dripper line hoses are well known in the art and are used for the irrigation of a variety of plants. The irrigation may take place in vineyards, orchards, greenhouses, etc. The hoses may be any suitable hose such as a polyethylene hose having a wall thickness of approximately 40 millimeters. The diameter of the hoses typically range from 16 millimeters to 20 millimeters. The dripper line hoses are typically hung from the vines or trellis wire. In the past, the hose has been delivered to the site where it is unwound and the clips are manually attached to the hose typically by a snap fit. Then, the wire is secured to the clip to hang the dripper line hose for subsequent use during irrigation. This process is slow and expensive as it requires substantial labor to install the clips over the hundreds of feet of hose.

The present invention addresses the problems associated with the prior art and provides for a factory installed clip on the hose.

### SUMMARY OF THE INVENTION

The invention is a clip and irrigation hose assembly from a wire comprising a length of irrigation hose and a plurality of clips installed at a factory on a hose. The clips have a hook member, wherein the hook is connected to the wire, thereby suspending the clip and irrigation hose assembly.

In another embodiment, the invention is a clip and irrigation hose assembly for suspension from a wire having a length of irrigation hose and a plurality of clips installed at a factory on the hose. A body having a generally ring shape has an opening, the opening allowing the body to be opened to allow insertion on the hose. A hook member is operatively connected to the body, the hook member for suspending the clip and hose assembly. The clip has a right half and a left half, the clip being symmetrical for easier automatic assembly. A semi-circular flange is operatively connected to the body, wherein the flange provides an extra wide surface on which the hose rests. A first locating tab is operatively connected to the right half and a second locating tab is operatively connected to the left half, thereby allowing for easier automatic assembly.

In a preferred embodiment, the clips include a body having a generally ring shape having an opening. The opening allows the body to be opened to allow insertion on the hose. A clip member is operatively connected to the body of the clip, the hook for suspending the clip and hose.

In another embodiment, the invention is a method of making a clip and irrigation hose assembly comprising securing a plurality of clips at spaced intervals on an irrigation hose at a factory. The hose and clips are then coiled, whereby the assembly of clips and hose are able to be shipped to a site for subsequent installation by suspending the clips from a wire.

### BRIEF DESCRIPTION OF THE DRAWINGS

FIG. 1 is a front elevational view of a clip of the present invention;

FIG. 2 is a right side elevational view of the clip shown in FIG. 1;

FIG. 3 is a left side elevational view of the clip shown in FIG. 1;

FIG. 4 is a rear elevational view of the clip of FIG. 1;

FIG. 5 is a cross sectional view taken generally along the lines 5-5 of FIG. 1;

FIG. 6 is an enlarged detail of a portion of FIG. 5;

FIG. 7 is a side elevational view of the clip of FIG. 1 installed on a hose;

FIG. 8 is a schematic representation of the hose and clip of FIG. 7 rolled up after being produced in the factory;

FIG. 9 is a front elevational view of a second embodiment of the clip of the present invention;

FIG. 10 is a right side elevational view of the clip of FIG. 9;

FIG. 11 is a left side elevational view of the clip of FIG. 9;

FIG. 12 is a rear elevational view of the clip of FIG. 9;

FIG. 13 is a cross sectional view taken generally along the lines 13-13 of FIG. 9;

FIG. 14 is an enlarged detail of a portion of FIG. 13;

FIG. 15 is a perspective view of a third embodiment of the clip of the present invention;

FIG. 16 is a front elevational view of the clip shown in FIG. 15; and

FIG. 17 is a side elevational view of the clip shown in FIG. 15.

### DETAILED DESCRIPTION OF THE PREFERRED EMBODIMENT

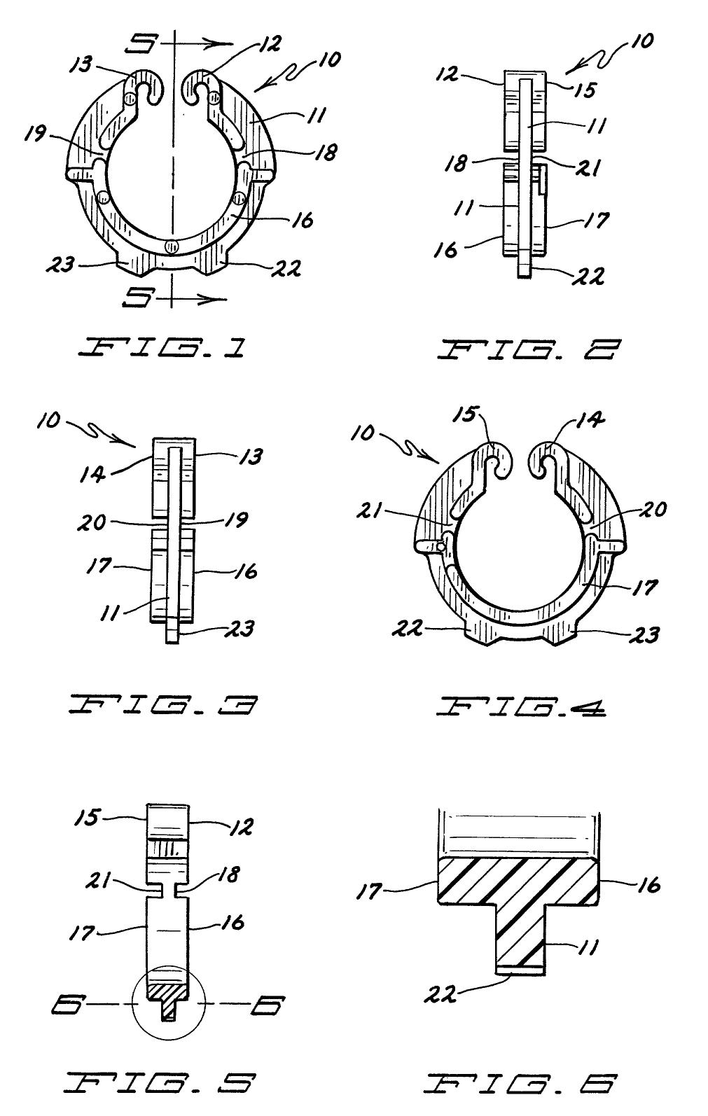

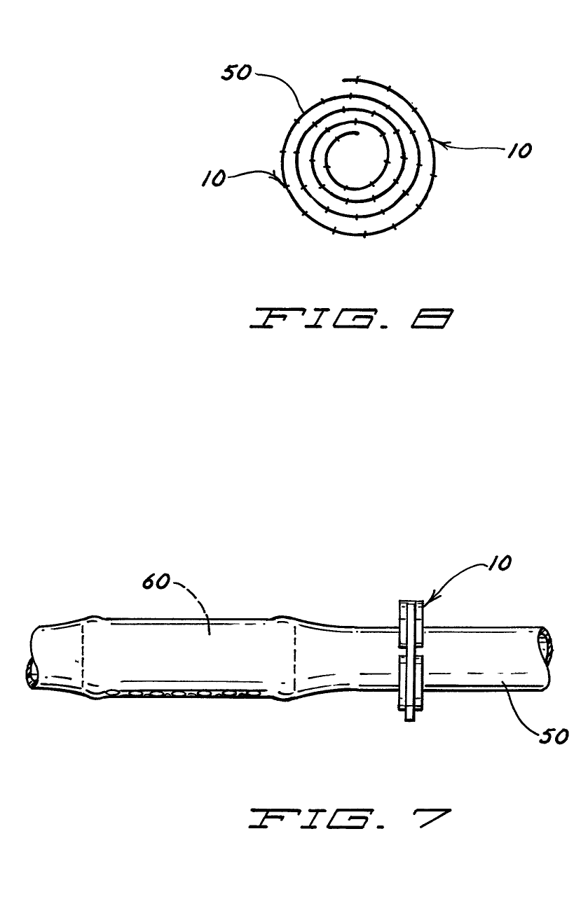

The first sheet of drawings contains FIGS. 1 through 6 showing a first embodiment of a clip 10 of the present invention. The clip 10 is in the general shape of a circle and is sized and configured to be assembled over an irrigation hose. The clip 10 may be made of different diameters to accommodate different sized hoses. The clip shown in FIGS. 1 through 6 is sized for a 20-millimeter hose. The clip 10 has a body 11 that is in the general shape of an annular ring having an opening at its top end. The clip 10 is symmetrical so that as viewed in FIG. 1, the right half is the same as the left half. Further, as viewed in FIG. 2, the front section is similar to the rear section. By being symmetrical, the clip 10 is constructed for easier automatic assembly. A first hook member 12 is formed on the right front side of the body 11 and a second hook 13 is formed on the front left side of the body 11. A third hook 14 and a fourth hook 15 are operatively connected to the rear right and left sides. The hooks are similar and only one will be discussed in detail. The hook forms a slot through which a wire is inserted to support the clip and hose. As shown in FIG. 2, the thickness of both the front and rear hooks combined is approximately 0.250 inches. The body 11 has a thickness of about 0.070 inches. A semicircular flange 16 is formed on the front side and a second semicircular flange 17 is formed on the back side. The flanges 16 and 17 provide for an extra wide surface on which the hose rests. This allows for the clip to stay at a 90-degree angle to the hose and not lay down on the hose. Gaps 18-21 are formed between the hooks 12-15 and the flanges 16, 17. The gaps 18-21 allow for tracking of the clip 10 on a vibratory bowl, as will be discussed more fully hereafter. Locating tabs 22 and 23 are formed proximate the bottom of the body 11 and are used in locating of the clip 10 in the assembly machine.

The clip 10 has a diameter D that is sized depending upon the hose on which the clip is designed to support. As shown in FIG. 1, the diameter is 0.805 inches. This is the typical diameter for use with a 20-millimeter hose. Such a diameter allows for the clip 10 to be secured around the hose but still allows the clip to slide on the hose by applying pressure sideways. The opening at the top of the clip 10 allows the right and left halves to be spread apart to allow the insertion of the clip onto the hose as will be discussed more fully hereafter. As can be seen in FIGS. 1 through 6, the upper portion of the body 11 is slightly larger than the lower portion of the body 11.

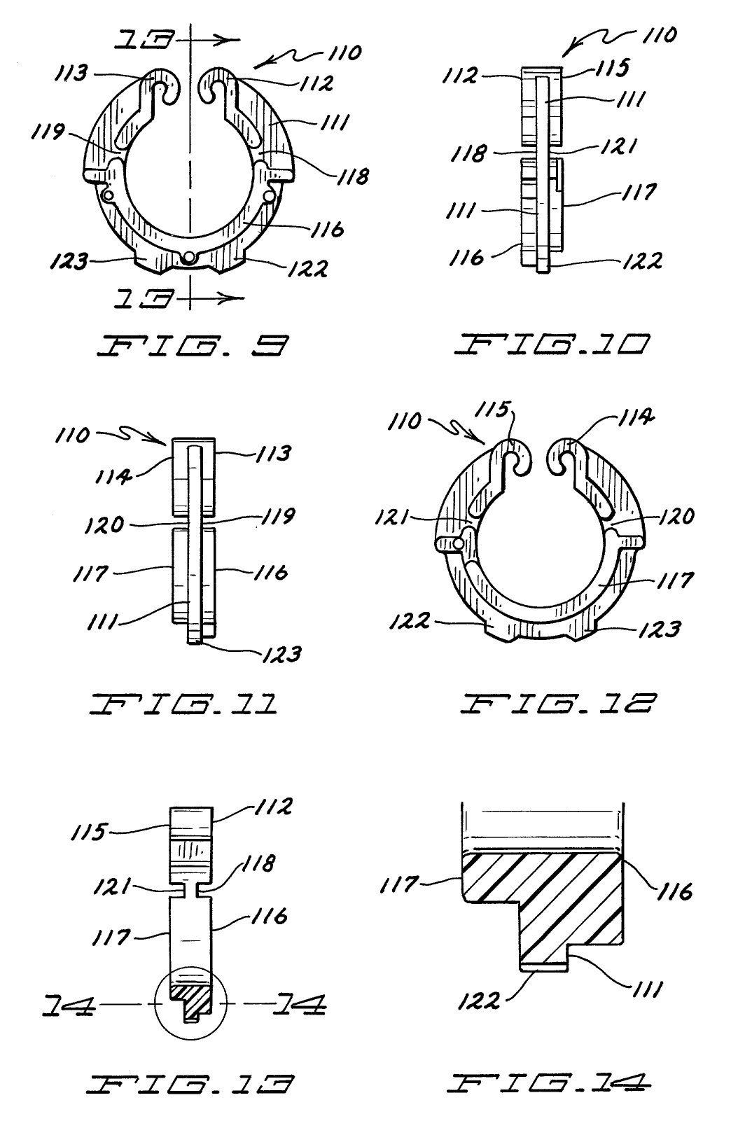

A second embodiment of the clip of the present invention is shown in FIGS. 9 through 14 and is generally designated at 30. The construction and configuration of the clip 30 is substantially the same as clip 10 and will not be described in detail. Only the differences will be delineated. The inner diameter of the clip 30 is 0.710 inches and is sized and configured to fit an 18-millimeter hose. Other parts may also be correspondingly reduced in size. The detail shown in FIG. 14 shows an enlarged area at the front, bottom of the clip 30. This is due to a different mold design being used and does not effect the function thereof.

FIGS. 7 and 8 show clips 10 assembled on a hose 50. The hose 50 has an internal drip emitter 60. However, it is also understood that button emitters may also be utilized. The clip 10 is factory installed on the hose 50 which provides for reduced labor and installation time at the irrigation location. The clip 10 is made from a durable plastic which will allow for automatic handling. One suitable plastic is a polyketone such as CARILON™ produced by Shell Chemical. Alternately, modified polyesters or other suitable plastics may be used which have the strength to withstand automatic handling equipment. The material should also be acid and chemical resistant.

The clips 10 may be automatically assembled to the hose 50 by suitable methods. One method would be to have a vibratory bowl feeder align the clips 10 and then have the clips delivered to an apparatus that would grasp the clip 10 proximate the hook area and spread apart the top end of the clip 10. Then, when the clip 10 is spread far enough apart to be positioned on the hose 11, the clip 10 would be inserted on the hose 50 and the mechanism holding the clip 10 open would be released, thereby allowing the clip 10 to be secured around the hose 50. Another method would be to move the clips 10 along on a cone having increasing diameter to gradually spread apart the clip 10. Then, at the end of the cone when the clip is sufficiently deflected, it is placed over the hose 50. FIG. 8 shows a schematic representation of a length of hose 50 with a plurality of clips 10 installed. The hose 50 may be of any suitable length. However, it would typically be many feet in length and include a substantial number of clips, the length typically being from 1000-1300 feet in length and up to 15,000-20,000 feet. The clips 10 are positioned at the typical spacings that one would use in the installation, such as when the clips are installed in the field.

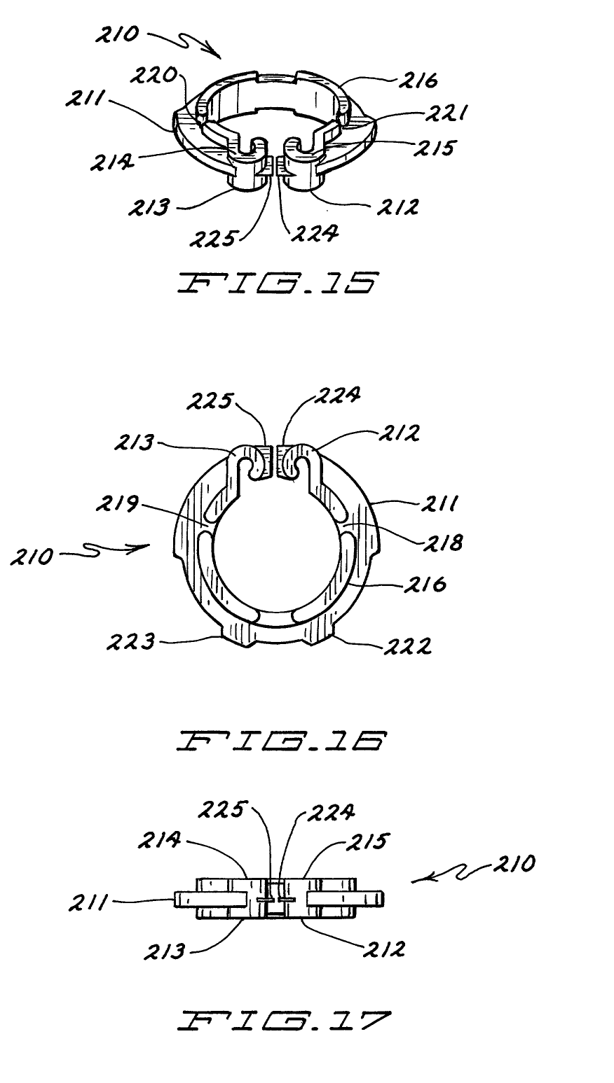

FIGS. 13 through 15 show a third embodiment of the present invention. The third embodiment is similar to the first embodiment shown in FIGS. 1 through 6 with the exception of not having the protuberance extending from the right and left top of the flange 16. In addition, the third embodiment includes another feature which is easily adaptable and for use with the first and second embodiments. This additional feature is two flanges 24 and 25 which extend from the center of the body 11. The flanges 24 and 25 are very thin and have the appearance of flashing from a typical plastic mold. The purpose of the flanges 24 and 25 are to stop the movement of water along the hose 50. If the hose 50 is at an incline, water may simply run down the length of the hose. By having the flanges 24 and 25, the drip of water on the hose 50 will be interrupted and will therefore fall to the ground at that point.

While the clips 10 and 30 have been described in detail, it is understood that any suitable clip may be utilized to take advantage of the present invention of preassembling the clips at the factory so as to eliminate the labor at the site. The clips could also be assembled by hand on the hose at the factory, but or course the savings would not be as great.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A clip and irrigation hose assembly for suspension from a wire, comprising:
a) a length of irrigation hose; and
b) a plurality of clips installed at a factory on the hose; and
c) the clips having a hook member, wherein the hook is connected to the wire, thereby suspending the clip and irrigation hose assembly.

2. The clip and irrigation hose assembly of claim 1, wherein the clips further comprise:
a) a body having a generally ring shape having an opening, the opening allowing the body to be opened to allow insertion on the hose; and
b) the hook member operatively connected to the body.

3. The clip and irrigation hose of claim 2, the clip having a right half and a left half, the clip being symmetrical for easier automatic assembly.

4. The clip and irrigation hose of claim 3, further comprising a semicircular flange operatively connected to the body, wherein the flange provides an extra wide surface on which the hose rests.

5. The clip and irrigation assembly of claim 4, further comprising a first locating tab operatively connected to the right half and a second locating tab operatively connected to the left half, thereby allowing for easier automatic assembly.

6. A clip and irrigation hose assembly for suspension from a wire, comprising:
a) a length of irrigation hose;
b) a plurality of clips installed at a factory on the hose;
c) a body having a generally ring shape having an opening, the opening allowing the body to be opened to allow insertion on the hose;
d) a hook member operatively connected to the body, the hook member for suspending the clip and hose assembly;
e) the clip having a right half and a left half, the clip being symmetrical for easier automatic assembly;
f) a semi-circular flange operatively connected to the body, wherein the flange provides an extra wide surface on which the hose rests; and
g) a first locating tab operatively connected to the right half and a second locating tab operatively connected to the left half, thereby allowing for easier automatic assembly.

7. A method of making a clip and irrigation hose assembly comprising:
a) securing a plurality of clips at spaced intervals on irrigation hose at a factory; and
b) coiling the clips and hose, whereby the assembly of clips and hose are able to be shipped to a site for subsequent installation by suspending the clips from a wire.

8. The method of claim 7, further comprising securing the clips to the hose by an automatic process.
